(19) United States
(12) Patent Application Publication
(10) Pub. No.: US 2010/0035717 A1
(43) Pub. Date: Feb. 11, 2010

(54) LEVER-TYPE GEAR REDUCER

(75) Inventors: Nung Jun Tae, Chongjin City (KP); Yong Chol Kim, Chongjin City (KP); Yong Il Tae, Chongjin City (KP)

Correspondence Address: Hershkovitz & Associates, LLC, 2845 Duke Street, Alexandria, VA, 22314, US

(73) Assignee: Nung Jun Tae, North Hamgyong Province (KP)

(21) Appl. No.: 11/993,434

(22) PCT Filed: Dec. 8, 2005
(86) PCT No.: PCT/KP2005/000005

§ 371 Date: Dec. 20, 2007

(30) Foreign Application Priority Data
Jun. 20, 2005 (KP) P-05-128

(51) Int. Cl. F16H 48/06; B23P 15/00; F16H 57/08

(52) U.S. Cl. 475/149; 29/893.2; 475/343

(57) ABSTRACT

A speed reducer of the invention is a lever-typer speed reducer, which is configured to comprise a lever gear (4) which corresponds to an input gear of the conventional single-stage spur gear reducer but functions essentially in different manner, and a fulcrum gear (6), to increase a speed reduction ratio provide a self-locking feature and a stepless regulation of speed reduction by way of reducing or controlling the distance between a fulcrum (E) and a load bearing point (F).

### TECHNICAL FIELD OF THE INVENTION

This invention relates to a method for improving a reduction ratio and providing a self-locking feature of gear reducer comprising at least one lever gear having a first and a second meshing element, a fulcrum gear meshing with the first meshing element, and a output gear meshing with the second meshing element, and to a gear reducer made by such method.

### BACKGROUND OF THE INVENTION

A variety types of speed reducers are currently available, of which gear reducers are most widely used in the world, including typically a spur gear reducer, a bevel gearing reducer, a worm reducer, a planetary gear reducer, a spiral gear reducer, and an eccentric planetary gear reducer.

International Patent Application PCT/IT01/00640 discloses a multistage planetary speed reducer with spur gear meshing, of the type comprising at least one first stage, consisting of a first sun pinion driven by the coaxial driving shaft, a first set of planet gears supported by a first carrier disc and meshing with said first sun pinion and with a first fixed ring gear, and a second stage consisting of a second sun pinion driven by the coaxial said first carrier disc, a second set of planet gears carried by a second carrier disc and meshing with the said second sun gear and with a second ring gear.

European patent application 0 068 39 A2 teaches a two stage speed-reducer having a primary reduction stage the output gear of which is fixed to annular sleeve which acts as an eccentric on an output planetary gear to cause it to orbit within a fixed ring gear. The annular sleeve is formed with inner and outer races for coplanar bearings for the output gear and the planetary gear respectively.

U.S. Pat. No. 3,037,400 discloses a two sage reducer wherein an eccentric, drives, through bearings, a stepped pinion which mates with a stationary ring gear and an output ring gear.

U.S. Pat. No. 3,939,737 discloses an arrangement wherein a stepped pinion is eccentrically driven by an input shaft, through bearings, for engagement with a fixed gear and an output ring gear.

U.S. Pat. No. 4,235,129 discloses an arrangement wherein the hub of an input pulley is the eccentric for driving a floating pinion that coacts with an output ring gear. The eccentric hub forms the inner race for the bearings which permit rotation of the floating pinion.

U.S. Pat. No. 4,155,276 discloses an arrangement wherein first and second stage spur gears are driven by eccentric ring gears.

U.S. Pat. No. 3,602,070 discloses an arrangement wherein orbital movement of a floating gear is accomplished by planetary rollers or gears of different sizes.

And Chinese patent application 02153089.0 discloses a cycloid pin gear reducer wherein a rotation of an input shaft causes, via an eccentric element an orbital rotational movement of an input cycloidal gear in engagement with a stationary ring gear and an output cycloidal gear in engagement with an output ring gear.

The conventional speed reducers are such that reduction ratio at one stage is relatively low, and therefore it is needed to increase the dimensions of gears and/or reduction stages of the reducers to gain a high reduction ratio. Generally, it has been conventional that increasing a reduction ratio incurs loss of transmission efficiency and deterioration of operation,

Moreover, there does not exist any speed reducer having all the features of high reduction ratio, high transmission efficiency and self-locking which is an important requirement for a lifting device such as an winch.

Furthermore, there has not been suggested a speed reducer which can operate in a stepless speed reduction manner under rigid transmission.

### SUMMARY OF THE INVENTION

Accordingly, it is an object of the present invention to provide a method to raise a reduction ratio with high transmission efficiency, and a speed reducer made by the method.

Another object of the invention is to provide a speed reducer having a self-locking feature as well as a small size and a few components thereof.

It is a yet another object of the invention to provide a speed reducer which can operate with stepless regulation of speed reduction under rigid transmission.

These and other objects, characteristics and advantages of the invention are achieved by the method and the speed reducer according to the invention.

A speed reducer of the invention is one of new type, designated by the present inventor and referred to hereinafter as a lever-type speed reducer, which is configured to comprise a gear, referred to as a lever gear hereinafter, which corresponds to an input gear of the conventional single-stage spur gear reducer but functions essentially in different manner, and a further gear referred to as a fulcrum gear hereinafter, to realize a high speed reduction ratio, a self-locking feature and a stepless regulation of speed reduction by way of reducing or controlling the distance between a support point or a fulcrum and a load bearing point.

Specifically, the speed reducer of the invention comprises an input shaft with a carrier means fixedly secured thereto; at least one lever gear supported by the carrier means to rotate about its own central axis with simultaneously orbiting around the input shaft; fulcrum gear coaxially positioned with an output gear, wherein the lever gear has a first meshing element to mate with a fulcrum gear and a second meshing element to mate with a output gear.

In one embodiment of the speed reducer according to the present invention, a plurality of the lever gears are arranged around the input shaft at a regular interval.

Preferably, the fulcrum gear of the present speed reducer is adapted to be nonrotatable relative to the input shaft.

More preferably, the fulcrum gear is fixedly secured to a casing of the reducer.

Another embodiment of the speed reducer of the present invention comprises a further stage comprising a first external gear firmly fixed to the input shaft, a second external gear rigidly secured to and coaxially with the fulcrum gear, and a third external gear supported by a appropriate shaft secured to a casing, in parallel to but apart from the input shaft, and meshing with the first and second external gears.

Still another embodiment of the speed reducer of the present invention comprises a worm gearing device, wherein a worm wheel is fixedly secured to the fulcrum gear and a worm is connected to a output shaft of an external actuator electric motor so that the reduction ratio of the reducer can be controlled as a function of a rotation speed of the actuator motor.

A method of increasing a reduction ratio of the reducer according to the present invention comprises steps of:
positioning the fulcrum gear coaxially with the output gear in a manner nonrotatable relative to the input shaft; and
modifying some or all of the four gears so that the first and the second meshing elements of the lever gear pan accurately mate with the fulcrum gear and the output gear, respectively.

Preferably, the modifying step is carried out by way of modifying the gears constituting the meshing which has a smaller distance between axes than the other meshing.

More preferably, the modifying step may be carried out by way of further modifying other gears so as to decrease the difference of diameter between the fulcrum gear and the output gear.

### BRIEF DESCRIPTION OF DRAWINGS

For a fuller understanding of the invention, reference should now be made to the detailed description thereof in conjunction with the accompanying drawings, wherein:

FIG. 1 is a schematic view of the conversion of conventional single-stage spur gear reducer from torque mode to lever mode;

FIG. 2 is a schematic view of transmission of an embodiment of a speed reducer according to the invention;

FIG. 3 is a perspective view of the speed reducer of FIG. 1, with partially taken away to show the details thereof;

FIG. 4 is a schematic view of transmission, of conventional planetary gear reducer;

FIG. 5 is a schematic view of another embodiment of the present reducer having a plurality of lever gears;

FIG. 6 is a schematic view illustrating the self-locking feature of the reducer according to the present invention;

FIG. 7 is a schematic view of a differential lever-type speed reducer according to the present invention;

FIG. 8 is a schematic view of a stepless regulative lever-type speed reducer according to the present invention; and

FIG. 9 is a perspective view of a winch made of the reducer according to the present invention.

### DETAILED DESCRIPTION OF PREFERRED EMBODIMENTS

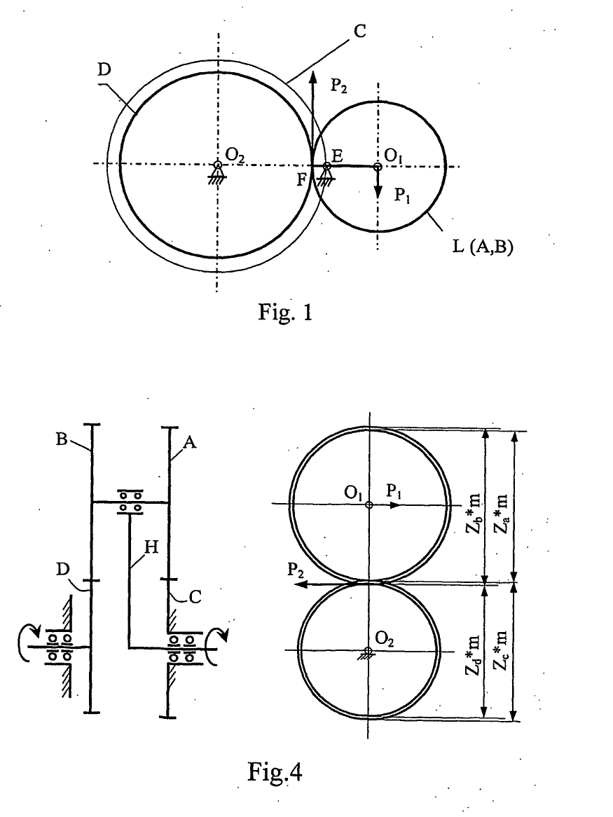

FIG. 1 is a schematic view to apply a lever effect to the conventional single-stage spur gear reducer. As can be seen, it becomes possible not only to increase the reduction ratio but also to achieve a self-locking feature, if converting the input gear of the conventional reducer to a lever gear L and providing with a fulcrum gear C. Furthermore, the reduction ratio even can be regulated steplessly by varying the distance between the fulcrum E and the load-bearing point F.

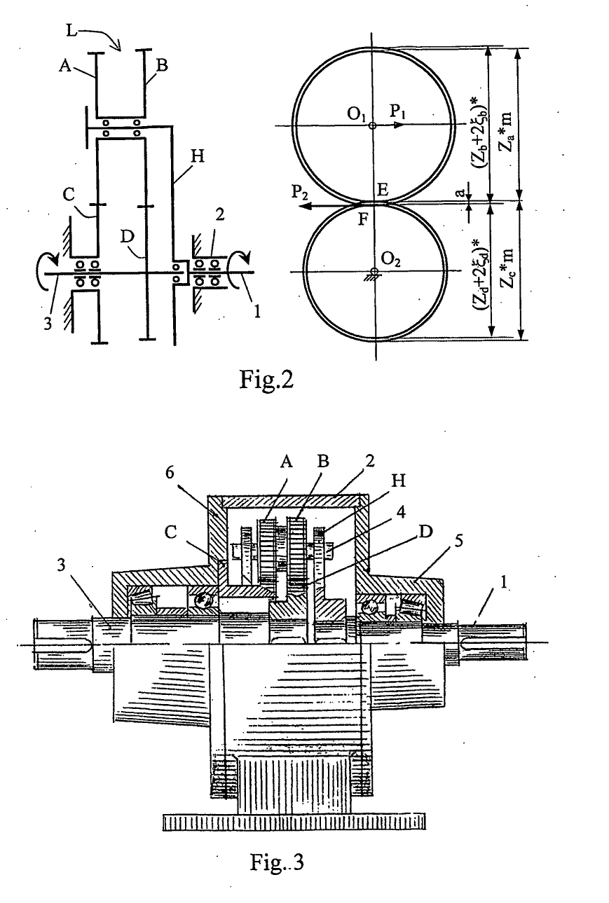

FIG. 2 shows a schematic view of transmission of an embodiment of present speed reducer. If an external force P₁ is applied to a central point O₁ of a lever arm gear A of the lever gear L mating with a fulcrum gear C at the fulcrum E, then the force P₂ according to the lever effect will be applied to a output gear D at the point F at which the output gear D mates with a load-bearing gear B of the lever gear L, and the torque M₂ of the output gear D will become as much as P₂*R, wherein the R is a radius of a pitch circle of the output gear D. The less the distance a between the fulcrum E and the meshing point F is, the more the torque of the output gear D, and in turn the higher the reduction ratio become.

Referring to 3, there is illustrated an embodiment of the speed reducer according to the present invention based on the lever effect, which comprises an input shaft 1 with a disk-like carrier means H fixedly secured thereto; at least one lever gear L supported by the carrier means H to rotate about its own central axis, at the same time to orbit around the input shaft 1; fulcrum gear C coaxially positioned with an output gear D, wherein the fulcrum gear C is of nonrotatable relative to the input gear 1 (as illustrated being fixed to a rear cover 6 of a casing 2) and of coaxial with the output gear D and the lever gear L has a lever arm gear A to mate with a fulcrum gear C and a load-bearing gear B to mate with a output gear D, the gears A and B being coaxial to each other.

The reducer operates as following: rotation of the input shaft 1 is transmitted, via the carrier means H to the lever arm gear A which orbits around the input shaft 1 due to the engagement with stationary fulcrum gear C and at the same time, rotates about a shaft 4 formed on and extending in parallel to the input shaft 1 from the carrier means H, so the output gear D meshing with the load-bearing gear B of the lever gear L becomes rotating at a reduced speed.

Now, the difference of the invention from the prior art will be described in comparison with the conventional 2K-H type planetary reducer of FIG. 4.

Reduction ratio (i) of the prior reducer is represented as following:

i=1/(1−Zb*Zc/(Za*Zd)),

wherein Za, Zb, Zc and Zd are teeth numbers of input planetary gear A, output planetary gear B, stationary gear C, and output gear D, respectively.

As per the reducer according to the present invention, in order to achieve a high reduction ratio as well as a self-locking feature, in case of external meshing as shown, the gears B and D is subjected to the positive (+) gear modification if (Za+Zc)>(Zb+Zd), otherwise gears A and C, to mate each other, wherein Za, Zb, Zc and Zd are teeth numbers of lever arm gear A, load-bearing arm gear B, fulcrum gear C, and output gear D, respectively. Thereafter, if the distance a of the meshing points (see FIG. 1) is not so small that the self-locking feature can be achieved, then all the gears A, B, C and D are subjected to positive (+) or negative (−) gear modification. For example, in case of modifying the gears B and D, the reduction ratio i is calculated as following:

i=Za*(Zd+2*ξd)/((Za+Zc)*(Zb+2*ξb−Za)),

wherein Za, Zb, Zc and Zd are teeth numbers of the lever arm gear A, load-bearing arm gear B, fulcrum gear C, and output gear D, respectively, and ξb and ξd are modification coefficients for gears B and D.

Also, for the internal meshing, similar gear modification is carried out, i.e. if (Zc−Za)<(Zd−Zb), then modification is subjected to the gears B and D, otherwise to gears A and C.

Table 1 shows the reduction ratios of both present lever-type reducer and prior planetary gear reducer under the same volume and module.

As can be seen from the Table 1, the lever-type reducer of present invention can have reduction ratio reaching even to some ten thousands by modifying the gears to come close the output gear D to the fulcrum E.

TABLE 1

| | | | | | | i | i |
|---|---|---|---|---|---|---|---|
| | | | | | | (of present | (of prior |
| | | | | | | lever-type | planetary |
| | | | | | | reducer of | gear reducer |
| Za | Zb | Zc | Zd | ξb | ξd | FIG. 1) | of FIG. 2) |
| 20 | 19 | 21 | 20 | 0.48718 | 0.51282 | 400 | |
| 20 | 21 | 21 | 20 | — | — | | 9.756 |
| 89 | 88 | 90 | 89 | 0.497175 | 0.50282 | 7919 | |
| 87 | 88 | 89 | 90 | — | — | | 3915 |

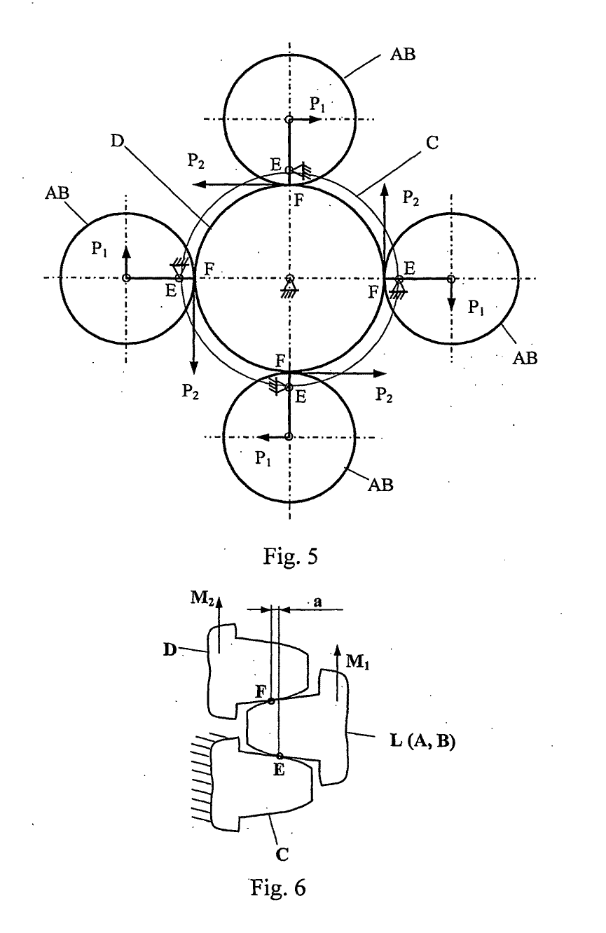

As can be seen from the FIG. 5, the speed reducer according to the present invention can have a plurality of lever gears L arranged around the input shaft 1 at a regular interval, to improve the load bearing capacity of the gears.

FIG. 6 shows schematically a self-locking principle of the reducer according to the present invention. When the lever gear L rotates in the direction of arrow M₁, the output gear D is allowed to rotate in the direction of arrow M₂. But, when the lever gear L tends to rotate in the opposite direction of arrow M₁, the load-bearing arm gear B becomes bit by the fixed fulcrum gear C and the output gear D, so that the lever gear L is not allowed to rotate.

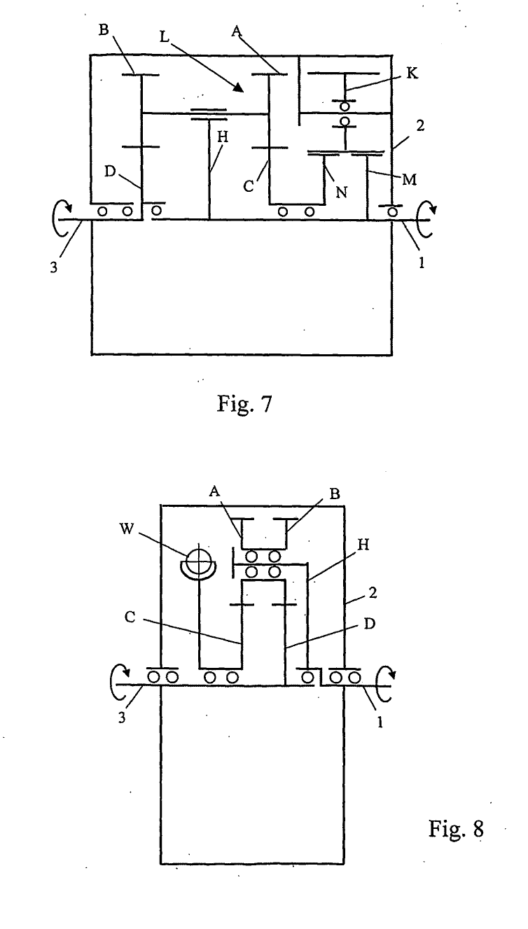

As per the lever-type speed reducer mentioned above, the rotation of the output gear is defined by the difference value of rotational speeds between the input shaft and the fulcrum gear. Thereby, it is possible to get extremely high reduction ratio by way of displacing the fulcrum gear. One embodiment of such reducer is shown at FIG. 7 in the form of transmission view. It should be noted that rotation direction should be same for both of the fulcrum gear and input shaft and the less differential value will lead to the higher reduction speed.

The differential lever-type speed reducer of FIG. 7 comprises a primary lever-type reduction stage comprising a lever gear L supported by a carrier means H fixedly secured to an input shaft 1 and having a lever arm gear A and a load-bearing arm gear B, and a fulcrum gear C; and a secondary differential reduction stage comprising a input gear M fixed to the input shaft 1, differential gear K and output gear N which is rigidly connected to the fulcrum gear C.

The reducer operates as following: rotation of the input shaft 1 cause the rotation of the input gear M of the secondary reduction stage and the carrier means H of the primary stage, consequently the fulcrum gear C of the primary stage, due to the meshing between gears M-K-N, rotates in the same direction of the input shaft 1 with the rotating speed of n₁*Zₖ/Zₙ, wherein n₁ is a number of rotation of the input shaft 1, and Zₖ and Zₙ are the teeth numbers of the input gear K and the output gear N, respectively. Thus, rotation of the lever gear L is determined by both of the rotational movements of the carrier means H and the fulcrum gear C, and finally the output gear D becomes to rotates at the reduced speed. The reduction ratio i of the reducer is as following when Zn−Zk=1:

i=Zn*Za*(Zd+2*ξd)/((Za+Zc)*(Zb+2*ξb−Za)),

wherein Za, Zb, Zc, Zd and Zn are teeth numbers of gears a, B, C, D and N, respectively, and ξb and ξd are modification coefficients for gears B and D.

For example, if Zn=Zc=31, Zd=Za=30, Zb=29, ξb=0.491525, ξd=0.508475, then reduction ratio i=27,900. Of course, it is required to modify the gears of the reducer as mentioned above, to let the gears mesh with each other.

FIG. 8 shows a still another embodiment of the speed reducer according to the present invention, capable of regulating the reduction ratio in stepless manner. This embodiment is substantially as same as one of FIG. 1 or 2, except that the fulcrum gear C is connected to a worm-gearing device W.

In this embodiment, when a worm wheel of the worm gearing device W rotates in the same direction of the input shaft 1, the fulcrum gear C connected thereto will become to rotate in the same direction, and therefore the rotational speed will vary depending upon the rotational speed of a worm of the worm gearing device W. Since the worm gearing device is of self-locking, the reducer maintains the self-locking feature of the lever-type reducer without affecting the transmission efficiency adversely. Moreover, because rotation of the input shaft 1 generates the force exerted to the fulcrum gear C to rotate it in the same direction thereof, the worm-gearing device can be driven by even small-power electric mortar.

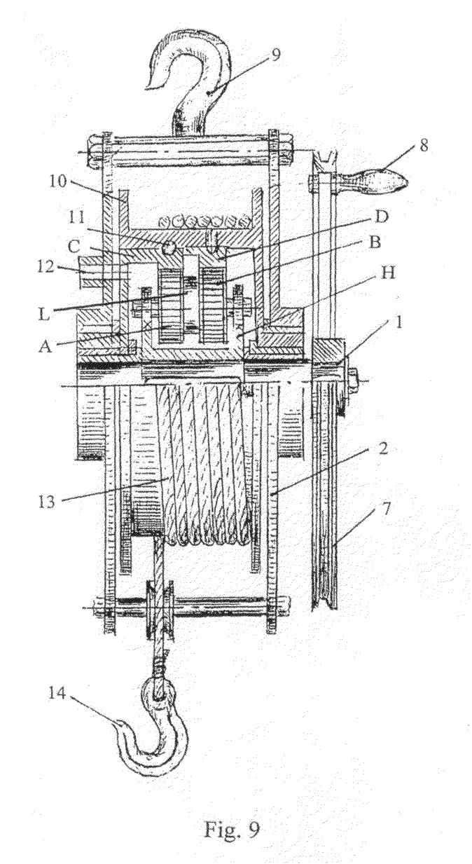

In FIG. 9, there is illustrated a winch made of a speed reducer according to the present invention, which comprises a pulley 7 to rotate an input shaft 1. When rotating the pulley 7 using a handle 8 mounted thereon, a lever gear 7 becomes to rotate via a carrier means H fixed to the input shaft 1. Then, a lever arm gear A of the lever gear L will rotate around the fulcrum gear C fixed to a casing by an appropriate fastening means 12, and a load-bearing gear B will rotate a output gear D fixed to a sheave 10 to wind or unwind a rope 13.

Preferred embodiments of the present invention have now been described; however, changes will obviously occur to those skilled in the art without departing from the spirit thereof. It is therefore, intended that the invention is to be limited only by the scope of the appended claims.

1-10. (canceled)

11. A method of increasing a reduction ratio of a speed reducer which comprises at least one lever gear supported by a carrier means rigidly fixed to a input shaft to rotate about its own central axis and at the same time to orbit around the input shaft and having a first meshing element and a second meshing element, a fulcrum gear and a output gear, wherein said method comprises the steps of:
positioning the fulcrum gear coaxially with the output gear in a manner nonrotatable relative to the input shaft; and
modifying some or all of the four gears so that the first and the second meshing elements of the lever gear can accurately mesh with the fulcrum gear and the output gear, respectively.

12. The method of claim 11, wherein said modifying step is carried out by way of modifying the gears constituting the meshing which has a smaller distance between axes than the other meshing.

13. The method of claim 12, wherein said modifying step may be carried out by way of further modifying other gears so as to decrease the difference of diameter between the fulcrum gear and the output gear.

14. A speed reducer made by using the method of claim 11, wherein the speed reducer comprises at least one lever gear supported by a carrier device rigidly fixed to a input shaft to rotate about its own central axis and at the same time to orbit around the input shaft and having a first meshing element and a second meshing element, a fulcrum gear and a output gear.

15. The speed reducer of claim 14, wherein said first meshing element and a second meshing element of said at least one lever gear, said fulcrum gear and said output gear are all the external gears.

16. The speed reducer of claim 15, wherein a plurality of lever gears are supported by said carrier means around said input shaft at a regular interval.

17. The speed reducer of claim 14, wherein said first meshing element and said second meshing element of the lever gear are external gears, whereas said fulcrum gear and said output gear are internal gears.

18. The speed reducer of claim 11, wherein said fulcrum gear is fixedly secured to a casing of the reducer.

19. The speed reducer of claim 14, wherein the reducer further comprises a secondary stage comprising a first external gear fixed to the input shaft, a second external gear fixedly and coaxially connected to the fulcrum gear to rotate about the input shaft, and a third external gear supported by a shaft fixed to a casing in parallel to but apart from the input shaft to rotate around the input shaft, the third external gear meshing with said two external gears.

20. The speed reducer of claim 15, wherein the reducer further comprises a secondary stage comprising a first external gear fixed to the input shaft, a second external gear fixedly and coaxially connected to the fulcrum gear to rotate about the input shaft, and a third external gear supported by a shaft fixed to a casing in parallel to but apart from the input shaft to rotate around the input shaft, the third external gear meshing with said two external gears.

21. The speed reducer of claim 16, wherein the reducer further comprises a secondary stage comprising a first external gear fixed to the input shaft, a second external gear fixedly and coaxially connected to the fulcrum gear to rotate about the input shaft, and a third external gear supported by a shaft fixed to a casing in parallel to but apart from the input shaft to rotate around the input shaft, the third external gear meshing with said two external gears.

22. The speed reducer of claim 17, wherein the reducer further comprises a secondary stage comprising a first external gear fixed to the input shaft, a second external gear fixedly and coaxially connected to the fulcrum gear to rotate about the input shaft, and a third external gear supported by a shaft fixed to a casing in parallel to but apart from the input shaft to rotate around the input shaft, the third external gear meshing with said two external gears.

23. The speed reducer of claim 14, wherein the reducer further comprises a worm gearing device, and wherein a worm wheel is fixedly secured to the fulcrum gear coaxially thereto, and a worm is connected to an output shaft of an electric mortar so that the reduction ratio of the reducer can be regulated steplessly as a function of rotation speed of the mortar.

24. The speed reducer of claim 15, wherein the reducer further comprises a worm gearing device, and wherein a worm wheel is fixedly secured to the fulcrum gear coaxially thereto, and a worm is connected to an output shaft of an electric mortar so that the reduction ratio of the reducer can be regulated steplessly as a function of rotation speed of the mortar.

25. The speed reducer of claim 16, wherein the reducer further comprises a worm gearing device, and wherein a worm wheel is fixedly secured to the fulcrum gear coaxially thereto, and a worm is connected to an output shaft of an electric mortar so that the reduction ratio of the reducer can be regulated steplessly as a function of rotation speed of the mortar.

26. The speed reducer of claim 17, wherein the reducer further comprises a worm gearing device, and wherein a worm wheel is fixedly secured to the fulcrum gear coaxially thereto, and a worm is connected to an output shaft of an electric mortar so that the reduction ratio of the reducer can be regulated steplessly as a function of rotation speed of the mortar.
